(19) United States
(12) Patent Application Publication
(10) Pub. No.: US 2007/0168928 A1
(43) Pub. Date: Jul. 19, 2007

(54) Computer-readable recording medium recording a part flow definition generation program, and part flow definition generation method and device

(75) Inventors: Koji Yamamoto, Kawasaki (JP); Kyoko Ohashi, Kawasaki (JP); Kazuki Munakata, Kawasaki (JP); Rieko Yamamoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/369,922

(22) Filed: Mar. 8, 2006

(30) Foreign Application Priority Data
Oct. 31, 2005 (JP) 2005-317593

(51) Int. Cl. G06F 9/44

(52) U.S. Cl. 717/104; 717/106

(57) ABSTRACT

A computer-readable recording medium recording a part flow definition generation program whereby service flow definitions of automatically executable processes and work flow definitions of processes involving input operation by humans can be automatically generated on the basis of a business process flow reflecting items approved by an operator side in respect of system construction. A business process flow storage stores a business process flow in which a subject of execution is set with respect to each of nodes associated with respective processes. A specific condition storage stores a specific condition including a subject of execution-based criterion as a criterion for identifying nodes that are to constitute a part flow definition, from among those in the business process flow. A target part extractor extracts, from the business process flow, the nodes satisfying the specific condition stored in the specific condition storage. A part flow definition generator generates a part flow definition.

### CROSS-REFERENCE TO RELATED APPLICATIONS

This application is based on, and claims priority to, Japanese Patent Application No. 2005-317593, filed Oct. 31, 2005, in Japan, and which is incorporated herein by reference.

### BACKGROUND OF THE INVENTION

1. Field of the Invention

The present invention relates to a computer-readable recording medium recording a part flow definition generation program for generating a part flow definition defining a procedure for performing of part of business processes, and part flow definition generation method and device. More particularly, the present invention relates to a computer-readable recording medium recording a part flow definition generation program for generating a part flow definition on the basis of a business process flow describing a procedure of business processes by means of multiple nodes, and part flow definition generation method and device.

2. Description of the Related Art

When developing a business system, the development needs to be conducted from a business viewpoint in order that client's orders may be correctly reflected in the business system. A problem that arises in the development stage is a gap in thought about the system between the following two groups:
A group consisting mainly of the management and operations department (who has knowledge of the business to be performed as well as the business functions which the business system is to aid). This group is hereinafter referred to as the “operator side”.
A group consisting mainly of the system vendor (who is knowledgeable about techniques and know-how of deploying the business system). This group is hereinafter referred to as the “vendor side”.

There are two gaps between these two sides, namely, a gap in mutual understanding (the operator side and the vendor side tend to use their own specialized words when explaining functions, so that the functions (use cases) which the operator side wishes to perform by the system fail to be fully understood by the vendor side), and a gap of time (when changes are made to the system, time is required to have the changes reflected in the actual system (it takes time to modify the system in accordance with changes of the business processes)).

As a guideline for solving the problem, a basic concept called “service-oriented development” has been proposed (according to the concept, functions performed by a business system are classified into units called “services”, which are easy for the operator side to handle, and the business system is constructed by combining the “services”). To develop a system in line with this basic concept, a means is required whereby business processes to be performed by the system are represented in a form understandable to the management and the operations department. One of such means is business process flow.

In the development of a business system based on a business process flow, functions necessary for the system are enumerated on the basis of business definitions of the business process flow, and an execution sequence (function call process flow) is determined. Tools for creating a call process flow based on process flow definitions have been proposed by a number of corporations (e.g., Unexamined Japanese Patent Publication No. 2001-92647).

There have also been proposed techniques for improving the quality of a model representing a business flow. For example, with respect to a sequence of operations performed as a functional unit, entity objects handled by the operations are discriminated in advance from control objects involving multiple entity objects, to improve the quality of an event trace diagram depicting the operation call relationships in order of occurrence (e.g., Unexamined Japanese Patent Publication No. H09-292981).

With the conventional techniques and tools, however, it is not possible to automatically generate only a flow to be deployed in the system, based on a business process flow which is a mixture of processes performed by humans and processes performed by the system. Also, a business process flow, which needs to be understood by the management and the operations department to allow them to give consent and approval to the system vendor side, usually consists of parts automatically performed by the business system and parts performed by humans even after the introduction of the business system. Conventionally, therefore, the below-mentioned “redundant procedure” is followed.

1. A flow including processes performed by humans is prepared for approval of the operator side.

2. A flow describing only mechanically called parts is separately prepared, and based on the flow, executable definitions are generated. Alternatively, a flow focused on parts performed by humans is separately prepared, and based on the flow, work flow definitions for mechanically managing human tasks are generated.

As a result, much time is required to modify the system in accordance with changes of the business processes. It is also possible that the system development is carried on based on faulty design because of misunderstanding or transcription error caused during the preparation of a separate flow including only the mechanically called parts.

In addition, there are a variety of rules for describing a business process flow which requires consent and approval of the management and the operations department. Also, call process flow definitions and work flow definitions are described in a variety of formats dependent on implementation platforms.

### SUMMARY OF THE INVENTION

The present invention was created in view of the above circumstances, and an object thereof is to provide a computer-readable recording medium recording a part flow definition generation program whereby a service flow definition of automatically executable processes and a work flow definition of processes involving input operations by humans can be automatically generated on the basis of a business process flow reflecting items consented by the operator side in respect of system construction, and part flow definition generation method and device.

To achieve the object, there is provided a computer-readable recording medium recording a part flow definition generation program for causing a computer to generate, based on a business process flow describing a procedure of business processes by means of multiple nodes, a part flow definition defining a procedure for performing part of the business processes. The part flow definition generation program causes the computer to function as a business process flow storage for storing a business process flow in which a subject of execution is set with respect to each of the nodes associated with respective processes, a specific condition storage for storing a specific condition including a subject of execution-based criterion as a criterion for identifying nodes that are to constitute a part flow definition, from among those in the business process flow, a target part extractor for extracting, from the business process flow, the nodes satisfying the specific condition stored in the specific condition storage, and a part flow definition generator for generating the part flow definition by defining, in accordance with the procedure defined in the business process flow, transition information indicative of process transition relationship between the nodes extracted by the target part extractor.

Also, to achieve the above object, there is provided a part flow definition generation method for causing a computer to generate, based on a business process flow describing a procedure of business processes by means of multiple nodes, a part flow definition defining a procedure for performing part of the business processes. The part flow definition generation method comprises the step of preparing in advance a business process flow storage storing a business process flow in which a subject of execution is set with respect to each of the nodes associated with respective processes, the step of storing, in a specific condition storage, a specific condition including a subject of execution-based criterion as a criterion for identifying nodes that are to constitute a part flow definition, from among those in the business process flow, the step of causing a target part extractor to extract, from the business process flow, the nodes satisfying the specific condition stored in the specific condition storage, and the step of causing a part flow definition generator to generate the part flow definition by defining, in accordance with the procedure defined in the business process flow, transition information indicative of process transition relationship between the nodes extracted by the target part extractor.

Further, to achieve the above object, there is provided a part flow definition generation device for generating, based on a business process flow describing a procedure of business processes by means of multiple nodes, a part flow definition defining a procedure for performing part of the business processes. The part flow definition generation device comprises a business process flow storage for storing a business process flow in which a subject of execution is set with respect to each of the nodes associated with respective processes, a specific condition storage for storing a specific condition including a subject of execution-based criterion as a criterion for identifying nodes that are to constitute a part flow definition, from among those in the business process flow, a target part extractor for extracting, from the business process flow, the nodes satisfying the specific condition stored in the specific condition storage, and a part flow definition generator for generating the part flow definition by defining, in accordance with the procedure defined in the business process flow, transition information indicative of process transition relationship between the nodes extracted by the target part extractor.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 schematically illustrates an embodiment of the present invention.

FIG. 2 is a conceptual diagram illustrating a method of generating a service flow definition.

FIG. 3 is a conceptual diagram illustrating a method of generating a work flow definition.

FIG. 4 shows an exemplary system configuration of the embodiment.

FIG. 5 exemplifies the hardware configuration of a system management server used in the embodiment.

FIG. 6 is a block diagram illustrating the function of the system management server.

FIG. 7 is a flowchart illustrating a part flow generation process.

FIG. 8 exemplifies a business process flow.

FIG. 9 is a first diagram illustrating deployment information relating to inventory management service.

FIG. 10 is a second diagram illustrating the deployment information relating to the inventory management service.

FIG. 11 is a third diagram illustrating the deployment information relating to the inventory management service.

FIG. 12 is a first flowchart illustrating a service flow definition generation process.

FIG. 13 is a second flowchart illustrating the service flow definition generation process.

FIG. 14 is a third flowchart illustrating the service flow definition generation process.

FIG. 15 exemplifies a service flow definition.

FIG. 16 is a first diagram illustrating an exemplary service flow definition.

FIG. 17 is a second diagram illustrating the exemplary service flow definition.

FIG. 18 is the first half of a flowchart illustrating a work flow definition generation process.

FIG. 19 is the latter half of the flowchart illustrating the work flow definition generation process.

FIG. 20 exemplifies a work flow definition.

FIG. 21 illustrates the manner of how a specific condition and a flow description format are looked up.

FIG. 22 illustrates a configuration whereby target part specification function and flow definition generation function can be switched.

### DESCRIPTION OF THE PREFERRED EMBODIMENTS

Preferred embodiments of the present invention will be described below with reference to the accompanying drawings, wherein like reference numerals refer to like elements throughout.

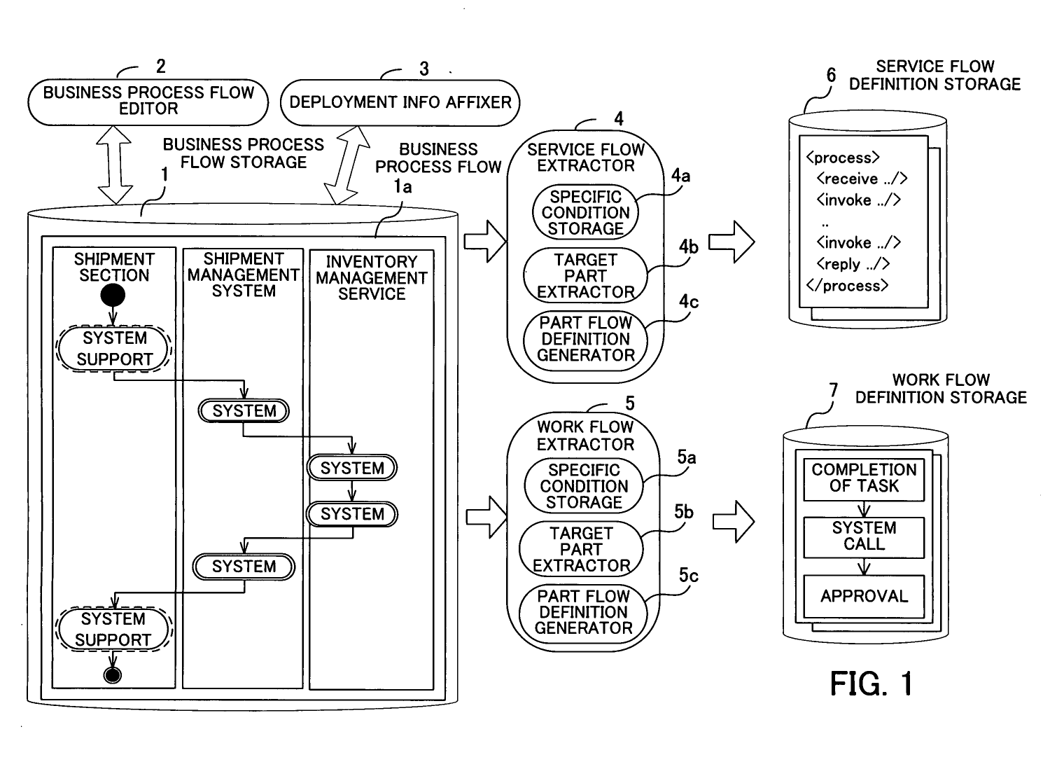

FIG. 1 schematically illustrates an embodiment of the present invention. Specifically, FIG. 1 illustrates the function whereby, on the basis of a business process flow 1a describing a procedure of business processes by means of multiple nodes, a service flow definition and a work flow definition are generated each as a part flow definition defining a procedure for performing part of the business processes. The service flow definition defines a sequence of processes executed by a computer system. The work flow definition defines a procedure of processes involving human tasks.

A business process flow storage 1 stores the business process flow 1a in which a subject of execution is set with respect to each of nodes associated with respective processes. The business process flow 1a can be created using a business process flow editor 2. Also, deployment information (info) necessary for deploying the function into a computer system can be affixed to the business process flow 1a by a deployment information affixer 3.

A service flow extractor 4 generates, based on the business process flow 1a, a service flow definition indicating a procedure of processes to be automatically executed by the computer system. To this end, the service flow extractor 4 includes a specific condition storage 4a, a target part extractor 4b, and a part flow definition generator 4c.

The specific condition storage 4a stores a specific condition including a subject of execution-based criterion as a criterion for identifying nodes that are to constitute a service flow definition, from among those in the business process flow 1a. The target part extractor 4b extracts, from the business process flow 1a, nodes satisfying the specific condition stored in the specific condition storage 4a. The part flow definition generator 4c generates a service flow definition by defining, in accordance with the procedure defined in the business process flow 1a, transition information indicative of process transition relationship between the nodes extracted by the target part extractor 4b.

A work flow extractor 5 generates, based on the business process flow 1a, a work flow definition indicating a procedure of processes to be performed by humans. To this end, the work flow extractor 5 includes a specific condition storage 5a, a target part extractor 5b, and a part flow definition generator 5c.

The specific condition storage 5a stores a specific condition including a subject of execution-based criterion as a criterion for identifying nodes that are to constitute a work flow definition, from among those in the business process flow 1a. The target part extractor 5b extracts, from the business process flow 1a, nodes satisfying the specific condition stored in the specific condition storage 5a. The part flow definition generator 5c generates a work flow definition by defining, in accordance with the procedure defined in the business process flow 1a, transition information indicative of process transition relationship between the nodes extracted by the target part extractor 5b.

A service flow definition storage 6 stores the generated service flow definition, and a work flow definition storage 7 stores the generated work flow definition.

The above function permits service and work flow definitions to be created from the business process flow 1a.

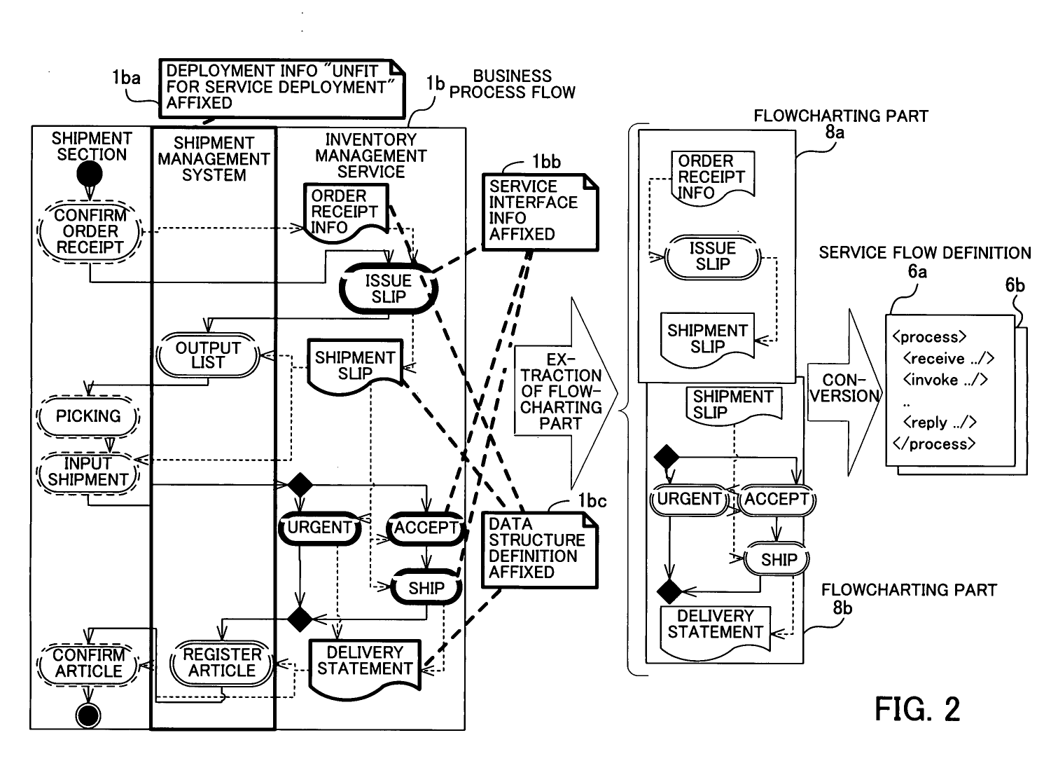

FIG. 2 is a conceptual diagram illustrating a method of generating a service flow definition. In the example of FIG. 2, processes to be performed by a shipment section, a shipment management system and an inventory management service are categorized under respective partitions of a business process flow 1b. Also, in the illustrated example, it is assumed that all processes of the shipment section involve humans as the subject of execution and that all processes of the shipment management system and the inventory management service involve the computer system as the subject of execution.

Further, the business process flow 1b is affixed with three items of deployment information (info), 1ba, 1bb and 1bc. The deployment information 1ba indicates that the processes of the shipment management system are “unfit for service deployment”. The deployment information 1bb shows service interface information (information indicating which program module is to be used to deploy service) for nodes associated with respective processes in the inventory management service. The deployment information 1bc shows definitions of data structures for input/output data.

The business process flow 1b is input to the service flow extractor 4, whereupon nodes indicating processes involving the computer system as the subject of execution are extracted. In this case, those nodes which are judged by the deployment information to be unfit for service deployment are excluded. As a result, two flowcharting parts 8a and 8b are extracted from the nodes belonging to the inventory management service. The flowcharting parts 8a and 8b are converted into a description format such as BPEL (Business Process Execution Language) to generate service flow definitions 6a and 6b.

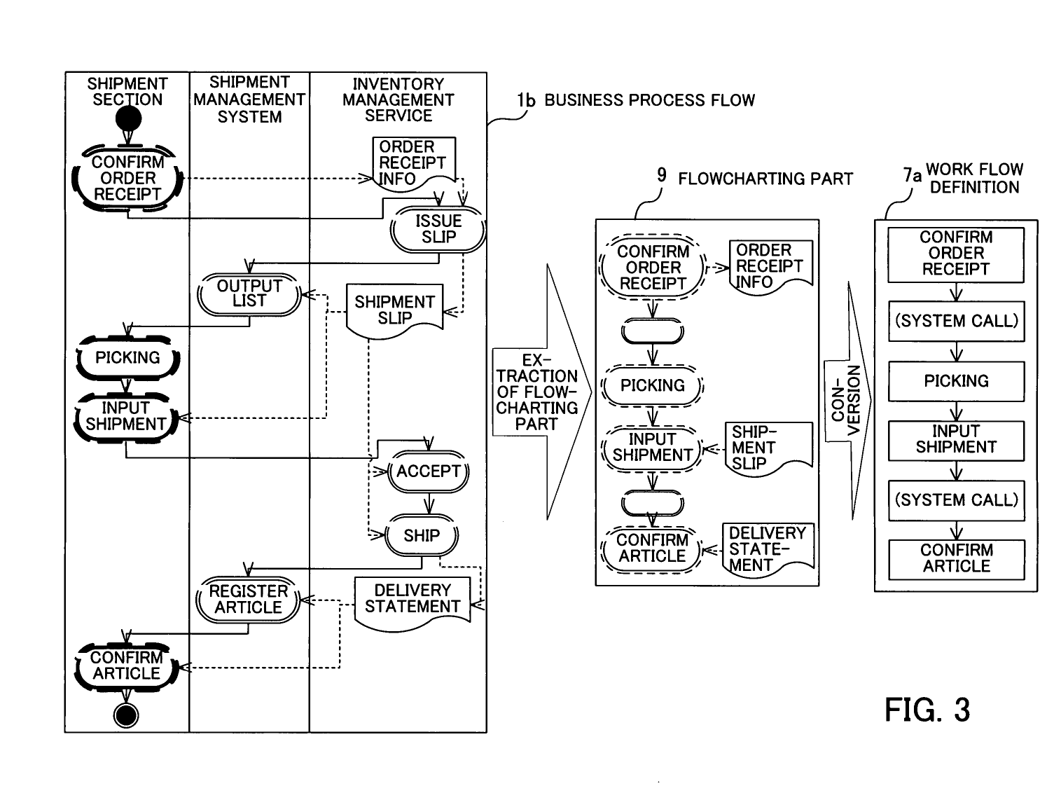

FIG. 3 is a conceptual diagram illustrating a method of generating a work flow definition. The illustrated business process flow 1b is identical with that shown in FIG. 2.

The business process flow 1b is input to the work flow extractor 5, whereupon nodes indicating processes involving human tasks are extracted. As a result, a flowcharting part 9 is extracted from the nodes belonging to the shipment section. The flowcharting part 9 is converted into a predetermined description format to generate a work flow definition 7a.

In this manner, service and work flow definitions can be automatically created from a business process flow. Thus, when the business process flow is changed in content, the changes can be instantly reflected in the part flow definitions. It is therefore possible to prevent delay in the system deployment based on the part flow definitions.

Further, by using the generated service flow definitions, it is possible to automatically deploy the corresponding service execution functions into servers. For example, in the case where a service flow definition is created in BPEL, a server is furnished with the function of interpreting BPEL and with execution modules for performing individual processes, whereby service corresponding to the service flow definition can be provided by the server. The embodiment will be now described in detail with reference to a system configuration wherein servers are adapted to provide services corresponding to service flow definitions.

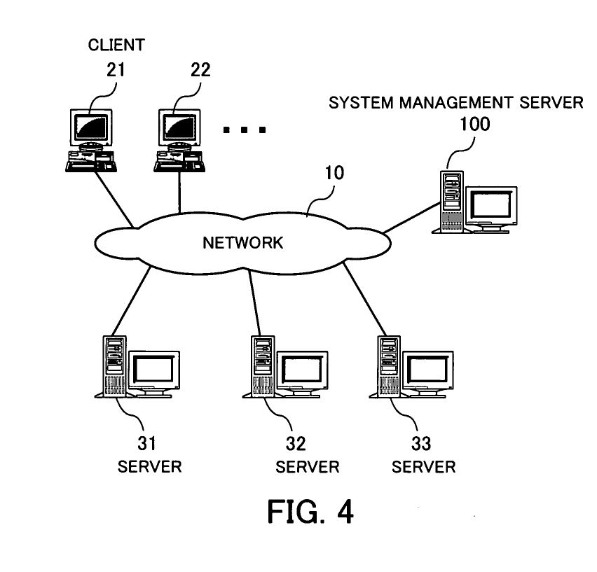

FIG. 4 shows an exemplary system configuration according to the embodiment. A system management server 100 is connected, via a network 10, with clients 21, 22, . . . and servers 31, 32 and 33.

The clients 21, 22, . . . are computers of users who use services provided by the servers 31, 32 and 33. The servers 31, 32 and 33 are computers which execute services in cooperation with one another to accomplish a sequence of business processes.

The system management server 100 is a computer for deploying service flow definitions into the respective servers 31, 32 and 33. At the system management server 100, a business process flow is created by the system administrator through input operation, and service flow definitions defining processes to be executed by the servers 31, 32 and 33 are generated on the basis of the business process flow. The system management server 100 deploys the service flow definitions into the respective servers 31, 32 and 33, whereby the servers 31, 32 and 33 can provide services corresponding to the respective service flow definitions.

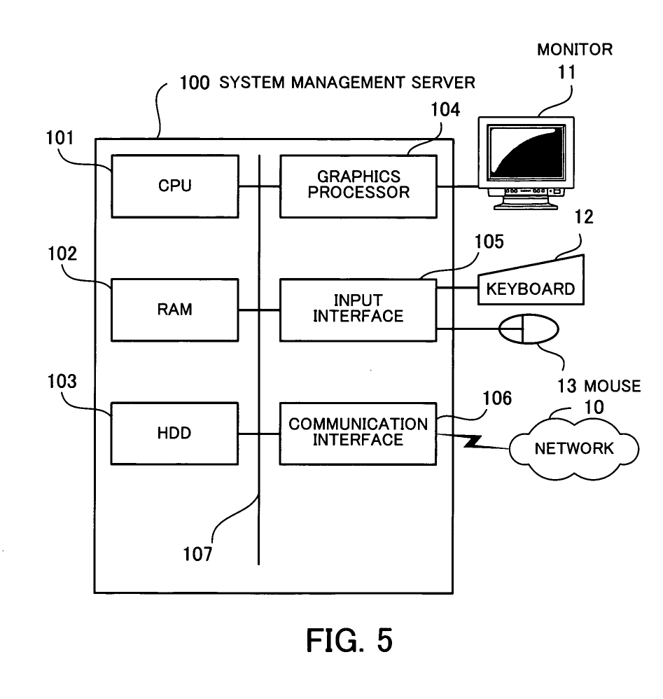

FIG. 5 shows an exemplary hardware configuration of the system management server used in the embodiment. The system management server 100 is in its entirety under the control of a CPU (Central Processing Unit) 101. To the CPU 101 are connected, via a bus 107, a RAM (Random Access Memory) 102, an HDD (Hard Disk Drive) 103, a graphics processor 104, an input interface 105, and a communication interface 106.

The RAM 102 temporarily stores OS (Operating System) and at least part of application programs executed by the CPU 101. Also, the RAM 102 stores various other data necessary for the processing by the CPU 101. The HDD 103 stores the OS and application programs.

The graphics processor 104 is connected with a monitor 11. In accordance with instructions from the CPU 101, the graphics processor 104 displays images on the screen of the monitor 11. The input interface 105 is connected with a keyboard 12 and a mouse 13, and sends signals from the keyboard 12 and the mouse 13 to the CPU 101 via the bus 107.

The communication interface 106 is connected to the network 10 and permits data to be exchanged with other computers via the network 10.

The processing function of the embodiment can be implemented by the hardware configuration described above. Although FIG. 5 shows the hardware configuration of the system management server 100, the clients 21, 22, . . . and the servers 31, 32 and 33 also may have a similar hardware configuration.

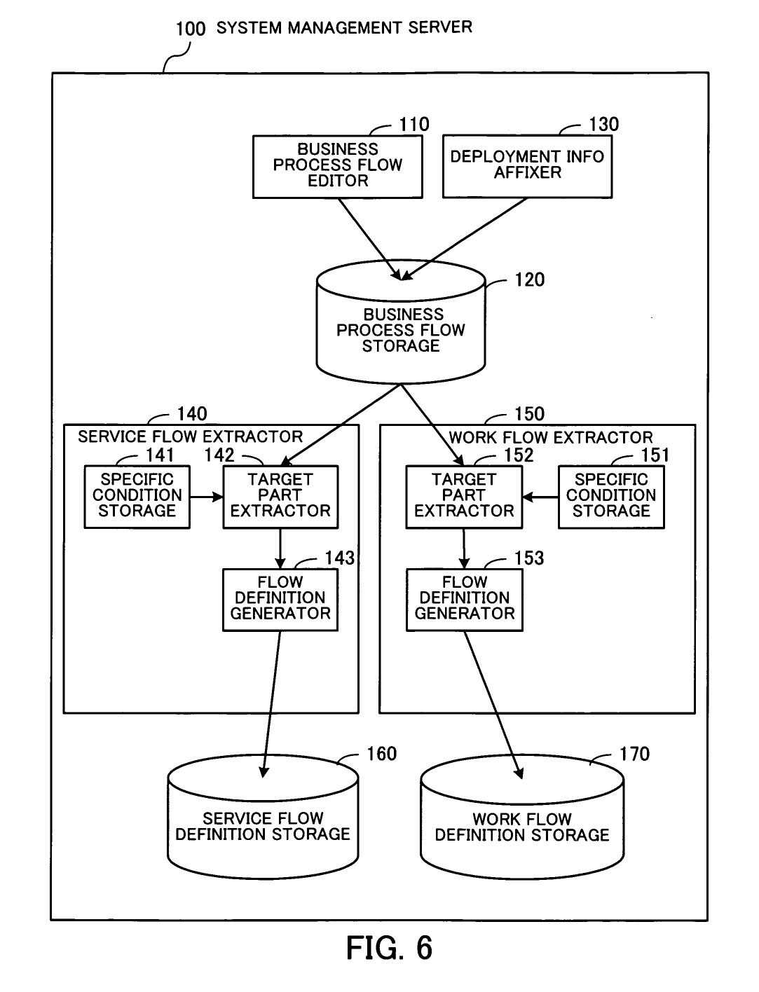

FIG. 6 is a block diagram illustrating the function of the system management server. The system management server 100 comprises a business process flow editor 110, a business process flow storage 120, a deployment information affixer 130, a service flow extractor 140, a work flow extractor 150, a service flow definition storage 160, and a work flow definition storage 170.

The business process flow editor 110 generates a business process flow in accordance with the data entered by the user. The generated business process flow has partitions which are associated with respective process categories and in which are placed nodes corresponding to respective processes to be executed. Also, the nodes are connected by a line to indicate the procedure of business processes. Each node represents an action that takes place during the course of execution of the business processes.

Further, in accordance with the user's data entry, the business process flow editor 110 edits the generated business process flow to, for example, generate a node indicative of a business process. At this time, the business process flow editor 110 affixes information indicative of a subject of execution of the process to the corresponding node constituting the business process flow, for example. The subject of execution of process includes “SYSTEM”, “SYSTEM SUPPORT”, and “HUMAN TASK”.

“SYSTEM” indicates that the process of the corresponding node is executed by the computer on the basis of input information and can be completed without the need for a human task, “SYSTEM SUPPORT” indicates that the process of the corresponding node is performed interactively between the computer and the user, and “HUMAN TASK” indicates that the process of the corresponding node is performed by a human task.

The business process flow editor 110 stores the generated business process flow in the business process flow storage 120.

The business process flow storage 120 is a storage device for storing the business process flow. For example, part of the storage area of the RAM 102 is used as the business process flow storage 120.

In accordance with the user's data entry, the deployment information affixer 130 affixes deployment information to the business process flow stored in the business process flow storage 120. For example, with respect to a partition of the business process flow, the deployment information affixer 130 can affix the deployment information “unfit for service deployment” which indicates that all processes in the partition should be excluded from service deployment. Further, the deployment information affixer 130 can affix XML (eXtensible Markup Language) schema information to a node.

Based on the business process flow stored in the business process flow storage 120, the service flow extractor 140 creates a service flow definition indicating a procedure of processes to be executed by the computer system. To this end, the service flow extractor 140 includes a specific condition storage 141, a target part extractor 142, and a flow definition generator 143.

The specific condition storage 141 stores in advance a specific condition for extracting elements to be used in creating a service flow definition, from the elements set in the business process flow. Where a plurality of specific conditions are stored, the specific condition storage 141 selects, in response to the user's input operation, a specific condition to be applied to the creation of a service flow based on the business process flow stored in the business process flow storage 120, from among the multiple specific conditions previously stored therein. Then, the specific condition storage 141 provides the target part extractor 142 with the selected specific condition.

The specific condition may include any of the following criteria, for example:

1. Processes agreed upon with the operator side as processes to be “automatically executed by system” (nodes with “SYSTEM” set as the subject of execution) should be extracted.

2. Transitional/branching/confluent processes between the processes agreed upon with the operator side as processes to be “automatically executed by system” should be extracted.

3. Notwithstanding the above two conditions, processes affixed with the deployment information “unfit for service deployment” should be excluded.

The target part extractor 142 determines whether to apply the criterion or not in accordance with the user's input.

Then, the target part extractor 142 identifies nodes (target part) satisfying the specific condition from the business process flow, and transfers the target part and the deployment information associated therewith to the flow definition generator 143.

Based on the target part and the deployment information transferred from the target part extractor 142, the flow definition generator 143 generates a service flow definition.

Based on the business process flow stored in the business process flow storage 120, the work flow extractor 150 creates a work flow definition indicating a procedure of processes to be executed by human tasks or by humans with the aid of the computer system. To this end, the work flow extractor 150 includes a specific condition storage 151, a target part extractor 152, and a flow definition. generator 153.

The specific condition storage 151 stores in advance a specific condition for extracting elements to be used in creating a work flow definition, from the elements set in the business process flow. Where a plurality of specific conditions are stored, the specific condition storage 151 selects, in response to the user's input operation, a specific condition to be applied to the creation of a work flow based on the business process flow stored in the business process flow storage 120, from among the multiple specific conditions previously stored therein. Then, the specific condition storage 151 provides the target part extractor 152 with the selected specific condition.

The specific condition may include any of the following criteria, for example:

1. Processes executed by human tasks and processes executed by humans with the aid of the system (nodes with “HUMAN TASK” or “SYSTEM SUPPORT” set as the subject of execution) should be extracted.

2. Transitional/branching/confluent processes between the processes executed by human tasks or by humans with the aid of the system should be extracted.

3. A sequence of processes automatically executed by the system (treated as a single process) should be extracted.

The target part extractor 152 determines whether to apply the criterion or not in accordance with the user's input.

Then, the target part extractor 152 identifies nodes (target part) satisfying the specific condition from the business process flow, and transfers the target part and the deployment information associated therewith to the flow definition generator 153.

Based on the target part and the deployment information transferred from the target part extractor 152, the flow definition generator 153 generates a work flow definition.

The service flow definition storage 160 is a storage device for storing the service flow definition generated by the service flow extractor 140. For example, part of the storage area of the RAM 102 is used as the service flow definition storage 160.

The work flow definition storage 170 is a storage device for storing the work flow definition generated by the work flow extractor 150. For example, part of the storage area of the RAM 102 is used as the work flow definition storage 170.

In the system management server 100 having the aforementioned function, a part flow generation process described below is carried out.

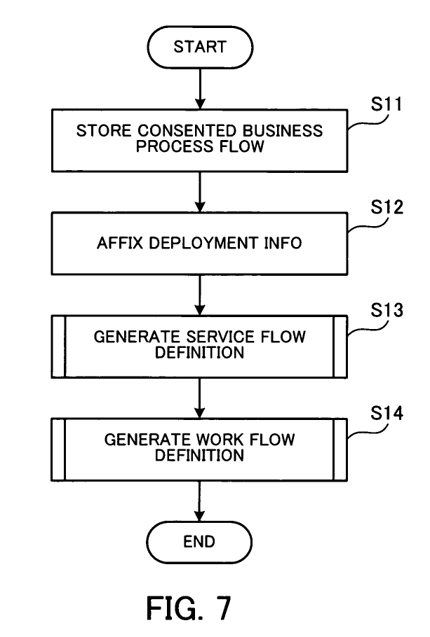

FIG. 7 is a flowchart illustrating the part flow generation process. In the following, the individual steps will be explained in order of step number.

STEP S11: Based on the data entered by an operator at the system vendor side, the business process flow editor 110 generates a business process flow and stores the generated business process flow in the business process flow storage 120.

The system vendor side has the generated business process flow reviewed by stakeholders (interested parties) of the operator side for approval, and after the operator side's approval is obtained, the subsequent steps are executed.

STEP S12: Based on the data entered by the operator at the system vendor side, the deployment information affixer 130 affixes deployment information to the business process flow stored in the business process flow storage 120.

STEP S13: The service flow extractor 140 generates service flow definitions based on the business process flow stored in the business process flow storage 120, and stores the generated definitions in the service flow definition storage 160. This step will be described in detail later.

STEP S14: The work flow extractor 150 generates work flow definitions based on the business process flow stored in the business process flow storage 120, and stores the generated definitions in the work flow definition storage 170. This step will be described in detail later.

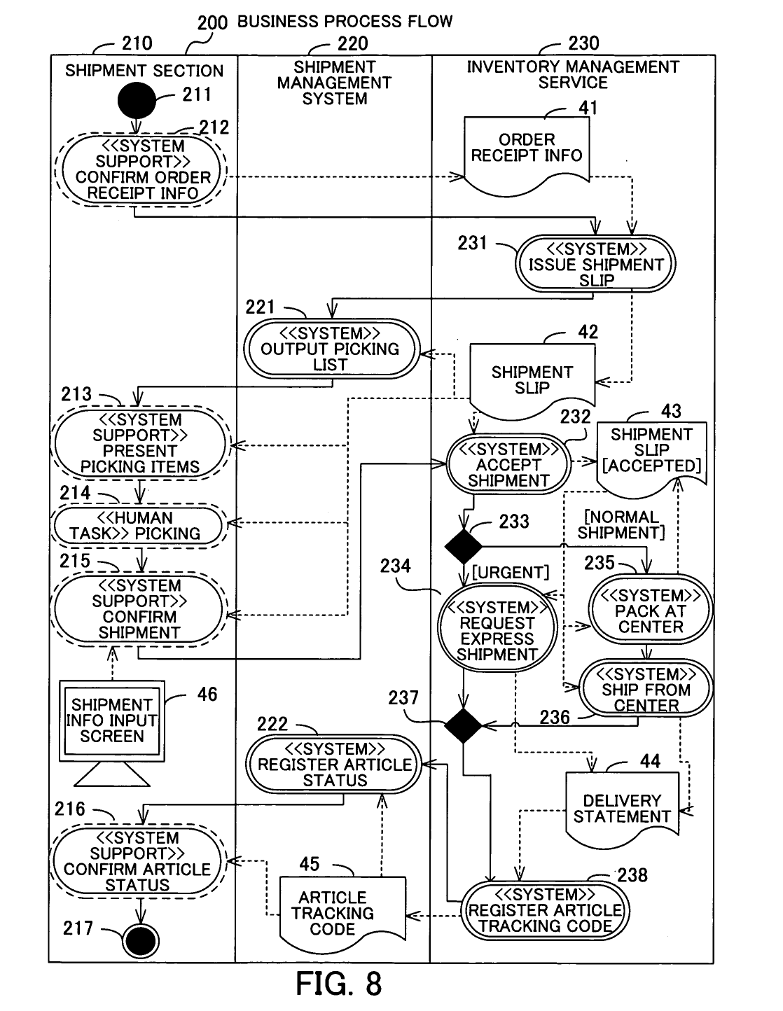

FIG. 8 illustrates an exemplary business process flow. In the example shown in FIG. 8, the business process flow 200 has three partitions 210, 220 and 230 associated with respective process categories.

The partition 210 shows processes to be executed by the shipment section, and seven nodes 211 to 217 are set in the partition 210. In FIG. 8, the transitional relationship of nodes is indicated by a solid line with an arrowhead, and the transfer of data is indicated by a broken line with an arrowhead.

The node 211 is a starting node and indicative of a process starting point.

The node 212 indicates an order receipt information confirmation process, and “SYSTEM SUPPORT” is set as the subject of execution. The node 212 is the destination of transition from the starting node 211.

The node 213 indicates a picking item presentation process, and “SYSTEM SUPPORT” is set as the subject of execution. The node 213 is the destination of transition from a node 221 in the partition 220 and is supplied with “SHIPMENT SLIP” data 42 from a node 231 in the partition 230.

The node 214 signifies a picking task, and “HUMAN TASK” is set as the subject of execution. The node 214 is the destination of transition from the node 213 and is supplied with the “SHIPMENT SLIP” data 42 from the node 231 in the partition 230.

The node 215 indicates a shipment input and confirmation process, and “SYSTEM SUPPORT” is set as the subject of execution. The node 215 is the destination of transition from the node 214 and is supplied with the “SHIPMENT SLIP” data 42 from the node 231 in the partition 230. Also, the node 215 is input with data entered on a shipment information input screen 46.

The node 216 indicates an article status confirmation process, and “SYSTEM SUPPORT” is set as the subject of execution. The node 216 is the destination of transition from a node 222 in the partition 220 and is supplied with “ARTICLE TRACKING CODE” data 45 from a node 238 in the partition 230.

The node 217 is a terminating node and indicative of a process terminating point.

The partition 220 shows processes to be executed by a shipment management system (information processing service provided by the computer system), and two nodes 221 and 222 are set in the partition 220.

The node 221 indicates a picking list output process, and “SYSTEM” is set as the subject of execution. The node 221 is the destination of transition from the node 231 in the partition 230 and is supplied with the “SHIPMENT SLIP” data 42 from the node 231.

The node 222 indicates an article status registration process, and “SYSTEM” is set as the subject of execution. The node 222 is the destination of transition from the node 238 in the partition 230 and is supplied with the “ARTICLE TRACKING CODE” data 45 from the node 238.

The partition 230 shows processes to be executed by the inventory management service (information processing service provided by the computer system), and eight nodes 231 and 238 are set in the partition 230.

The node 231 indicates a shipment slip issue process, and “SYSTEM” is set as the subject of execution. The node 231 is the destination of transition from the node 212 in the partition 210 and is supplied with “ORDER RECEIPT INFO” data 41 from the node 212.

The node 232 indicates a shipment acceptance process, and “SYSTEM” is set as the subject of execution. The node 232 is the destination of transition from the node 215 in the partition 210 and is supplied with the “SHIPMENT SLIP” data 42 from the node 231.

The node 233 indicates a branch decision process for determining whether the type of shipment is “URGENT” or “NORMAL SHIPMENT”. The node 233 is the destination of transition from the node 232.

The node 234 indicates an express shipment request process, and “SYSTEM” is set as the subject of execution. Transition from the node 233 to the node 234 takes place when it is judged at the node 233 that the type of shipment is “URGENT”. Also, the node 234 is supplied with “SHIPMENT SLIP (ACCEPTED)” data 43 from the node 232.

The node 235 indicates a center packing process, and “SYSTEM” is set as the subject of execution. Transition from the node 232 to the node 235 takes place when it is judged at the node 233 that the type of shipment is “NORMAL SHIPMENT”. Also, the node 235 is supplied with the “SHIPMENT SLIP (ACCEPTED)” data 43 from the node 232 and updates the data 43.

The node 236 indicates a center shipment process, and “SYSTEM” is set as the subject of execution. The node 236 is the destination of transition from the node 235 and is supplied with the “SHIPMENT SLIP (ACCEPTED)” data 43 from the node 235.

The node 237 signifies a confluence of transitions from the nodes 234 and 236.

The node 238 indicates an article tracking code registration process, and “SYSTEM” is set as the subject of execution. The node 238 is the destination of transition from the node 237 and is supplied with “DELIVERY STATEMENT” data 44 from the node 234 or 236.

Let it be assumed that the contents of the business process flow 200 generated in this manner are consented by the stakeholders of the operator side and that the shipment management system indicated by the partition 220 is to be excluded from the system currently constructed.

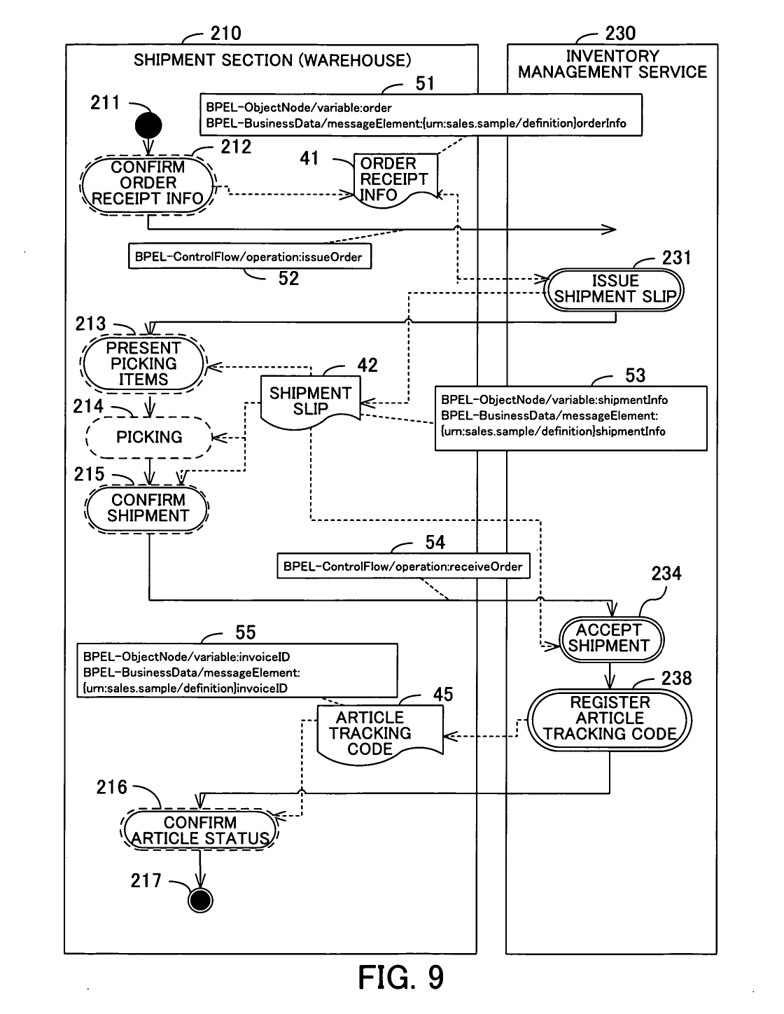

Then, with respect to the business process flow 200, a responsible person at the system vendor side sets deployment information necessary for the deployment of the system. Referring now to FIGS. 9 to 11, an exemplary case will be described wherein deployment information necessary for deploying the inventory management service is set using BPEL.

FIG. 9 is a first diagram illustrating the deployment information relating to the inventory management service. As illustrated, deployment information 51 to 55 relating to calls and returns with respect to the inventory management service is set in the partition 210 associated with the shipment section.

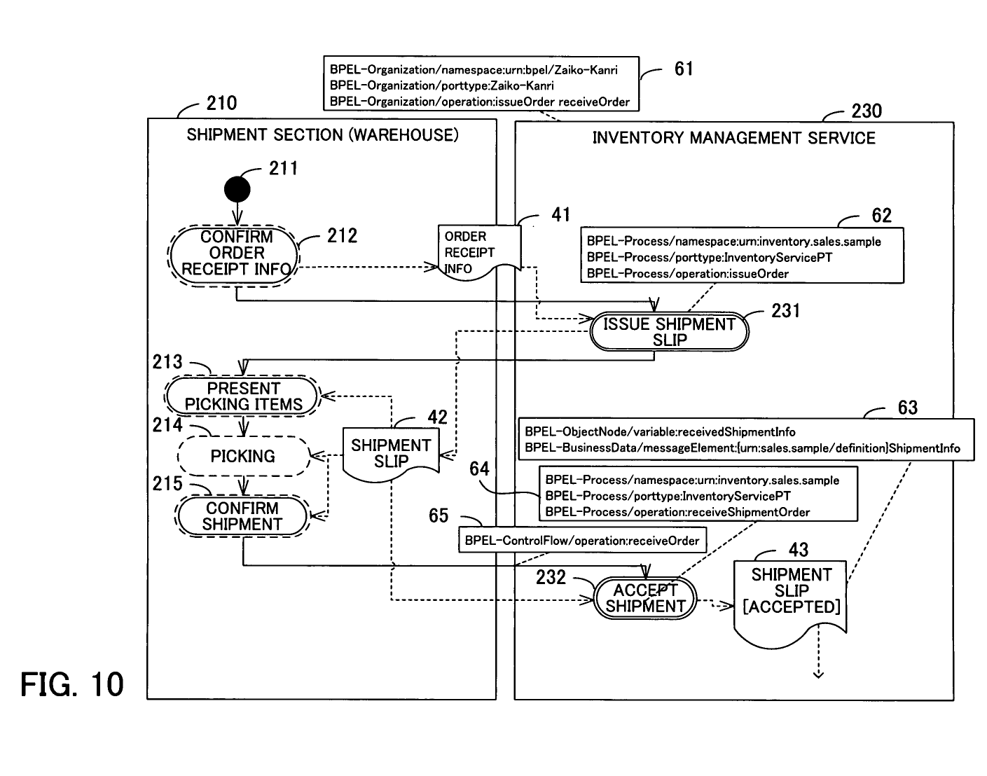

FIG. 10 is a second diagram illustrating the deployment information relating to the inventory management service. Deployment information 61 to 65 is set with respect to the first half of the partition 230 associated with the inventory management service.

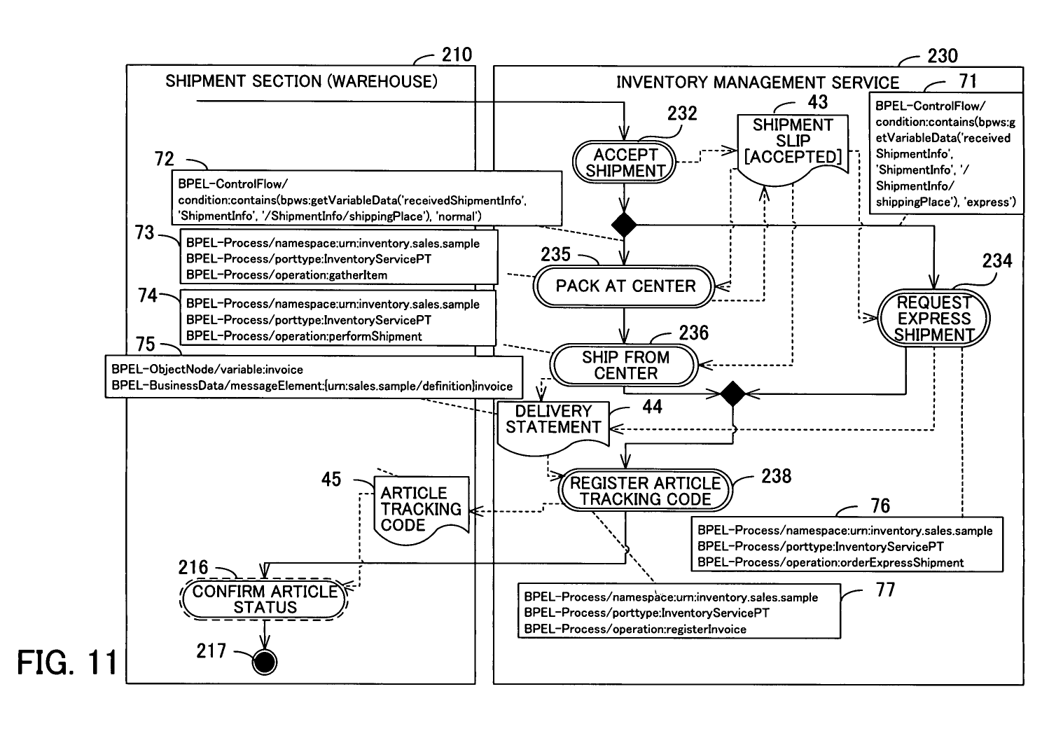

FIG. 11 is a third diagram illustrating the deployment information relating to the inventory management service. As illustrated, deployment information 71 to 77 is set with respect to the latter half of the partition 230 associated with the inventory management service.

The deployment information shown in FIGS. 9 to 11 is set with respect to the partitions 210 and 230, and the deployment information “unfit for service deployment” is set with respect to the partition 220, which is not shown in these figures. No deployment information needs to be set with respect to the individual elements in the partition 220 which is set as “unfit for service deployment”.

In FIGS. 9 to 11, the deployment information connected to a node holds information necessary for deploying the required process into the connected node. For example, the deployment information 62 shown in FIG. 10 holds information necessary for deploying the shipment slip issue process into the server. The first and second lines in the deployment information 62 indicate program modules to be started when the shipment slip issue process is executed by the server. The third line in the deployment information 62 indicates an applicable interface in the program modules.

Also, in FIGS. 9 to 11, the deployment information connected to a solid line connecting nodes defines a communication interface to be used for the input/output of data between the nodes. Further, in these figures, the deployment information connected to data defines a data structure. For example, XML document structure is defined by XML schema.

In FIG. 10, the deployment information 61 is information set with respect to the partition 230 as a whole.

Based on the business process flow 200 thus affixed with the deployment information, service and work flow definitions are generated.

First, the process for generating a service flow definition will be described in detail.

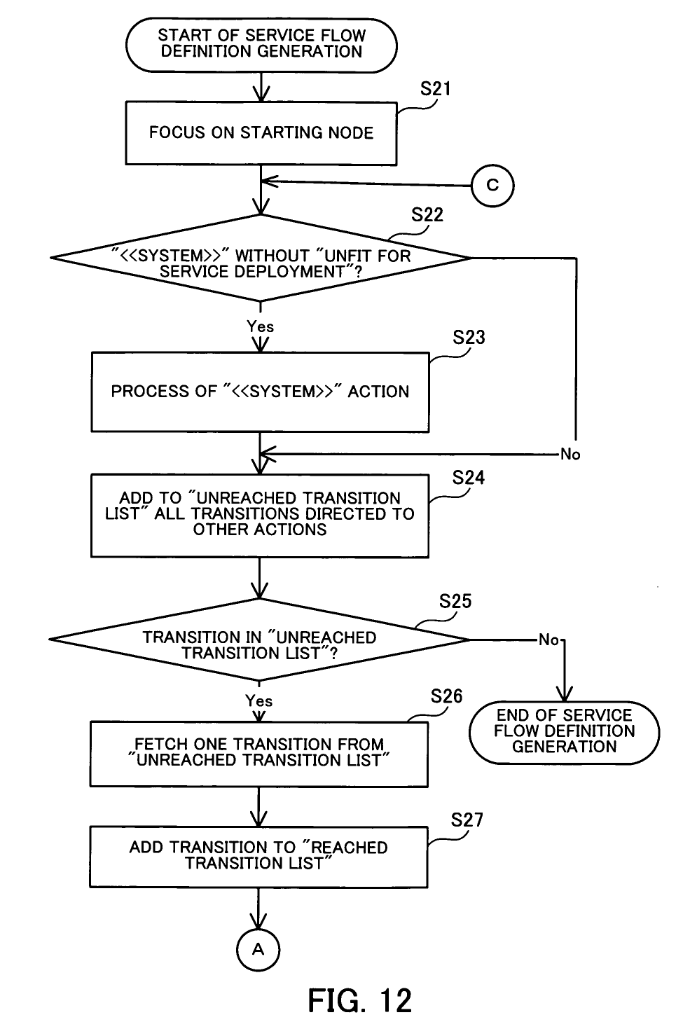

FIG. 12 is a first flowchart illustrating the service flow definition generation process. In the following, the individual steps will be explained in order of step number.

STEP S21: The target part extractor 142 of the service flow extractor 140 focuses on the starting node 211 of the business process flow 200.

STEP S22: The target part extractor 142 determines whether or not the condition is fulfilled that the node currently focused is a <<SYSTEM>> action and at the same time the deployment information “unfit for service deployment” is not set with respect to the partition to which the action belongs. If the condition is fulfilled, the process proceeds to Step S23; if not, the process proceeds to Step S24.

STEP S23: The flow definition generator 143 generates an element corresponding to the <<SYSTEM>> action in the service flow definition. In the case of BPEL, for example, an “invoke” node is generated.

STEP S24: With respect to each of the transitions directed to other actions, the target part extractor 142 adds, in an “unreached transition list”, transition information consisting of a pair of the transition (specifically, information including the identifier of the transition and the identifier of a node which is the destination of the transition) and the node currently focused (specifically, the identifier of the currently focused node). In this case, however, the transition information included in a “reached transition list” is excluded.

STEP S25: The target part extractor 142 determines whether or not transition information exists in the “unreached transition list”. If transition information exists, the process proceeds to Step S26; if there is no transition information, the process ends.

STEP S26: The target part extractor 142 fetches transition information from the “unreached transition list” and focuses on the node identified by the transition information. The fetched transition information is deleted from the “unreached transition list”.

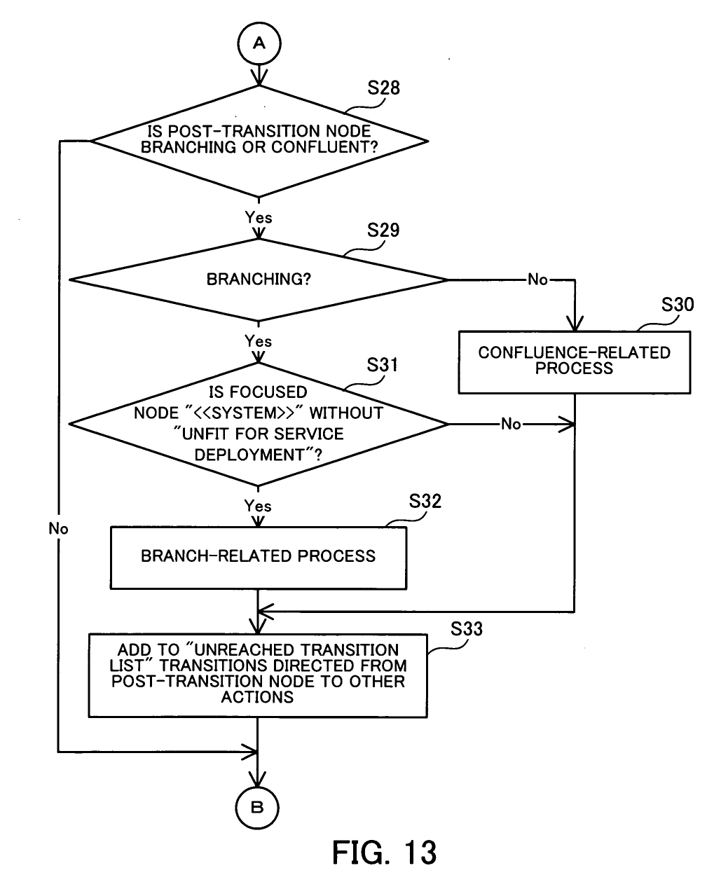

STEP S27: The target part extractor 142 adds the fetched transition information to the “reached transition list”, whereupon the process proceeds to Step S28 shown in FIG. 13.

FIG. 13 is a second flowchart illustrating the service flow definition generation process. The individual steps will be explained in order of step number.

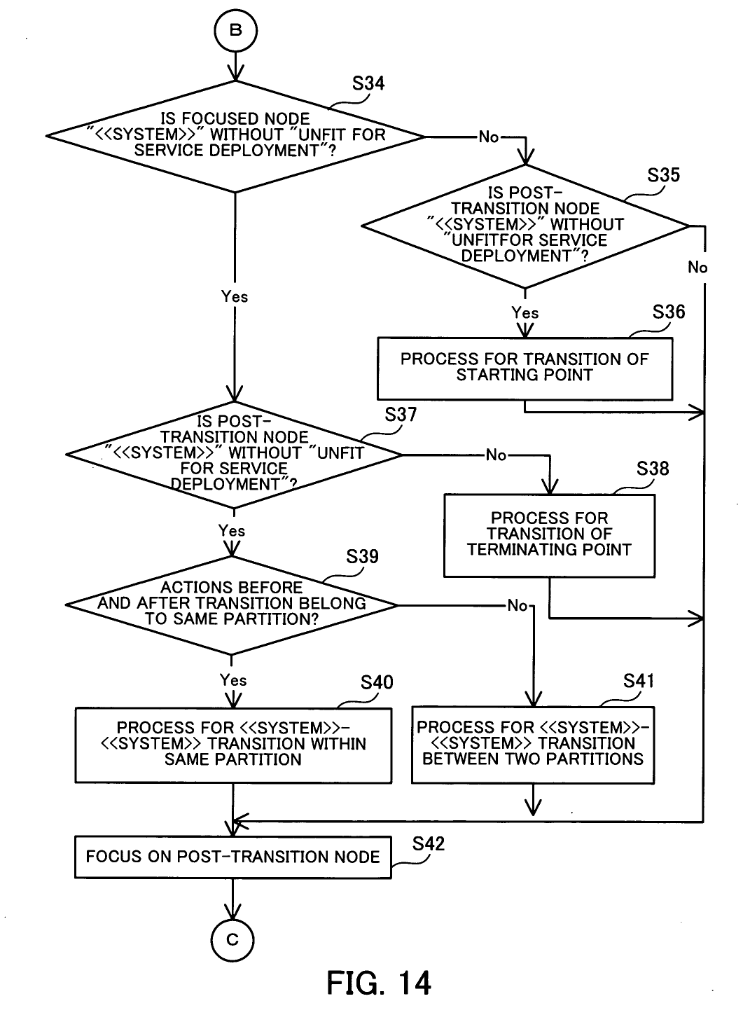

STEP S28: The target part extractor 142 determines whether or not the condition is fulfilled that the post-transition node identified by the fetched transition information is one of a conditional branching node (node with different transition destinations one of which is selected according to whether a condition is fulfilled or not), a parallel branching node (node with multiple transition destinations to which the process proceeds in parallel), a conditional confluent node (node to which the process proceeds if the source of transition fulfills a condition), and a parallel confluent node (node to which the process proceeds from multiple transition sources). If the condition is fulfilled, the process proceeds to Step S29; if not, the process proceeds to Step S34 in FIG. 14.

STEP S29: The target part extractor 142 determines whether or not the condition is fulfilled that the post-transition node succeeding the currently focused node is one of a conditional branching node and a parallel branching node. If the node is a conditional or parallel branching node, the process proceeds to Step S31; if the node is neither a conditional branching node nor a parallel branching node, the process proceeds to Step S30.

STEP S30: The flow definition generator 143 sets a confluence-related process in the service flow definition. In the case of BPEL, no confluence-related process is set. The process then proceeds to Step S33.

STEP S31: The target part extractor 142 determines whether or not the condition is fulfilled that the currently focused node is a <<SYSTEM>> action and at the same time the deployment information “unfit for service deployment” is not affixed to the partition to which the node belongs. If the condition is fulfilled, the process proceeds to Step S32; if not, the process proceeds to Step S33.

STEP S32: The flow definition generator 143 adds, to the service flow definition, a process relating to the branching of the currently focused node. In BPEL, for example, only if the node in question is a conditional branching node, a “TransitionCondition” attribute (information indicating a condition for effecting transition to the destination) is added to the “source” node generated immediately before. The process then proceeds to Step S33.

STEP S33: With respect to each of the transitions to other actions from the post-transition node (branching or confluent node), the target part extractor 142 adds, to the “unreached transition list”, transition information consisting of a pair of the transition and the currently focused node. In this case, however, the transition information included in the “reached transition list” is excluded. The process then proceeds to Step S34 in FIG. 14.

FIG. 14 is a third flowchart illustrating the service flow definition generation process. The steps shown in the figure will be explained in order of step number.

STEP S34: The target part extractor 142 determines whether or not the condition is fulfilled that the currently focused node is a <<SYSTEM>> action and at the same time the deployment information “unfit for service deployment” is not affixed. If the condition is fulfilled, the process proceeds to Step S37; if not, the process proceeds to Step S35.

STEP S35: This step is executed when the currently focused node is a <<HUMAN TASK>> action or a <<SYSTEM SUPPORT>> action or the deployment information “unfit for service deployment” is affixed to the partition to which the currently focused node belongs. In this step, the target part extractor 142 determines whether or not the condition is fulfilled that the post-transition node is a <<SYSTEM>> action and at the same time the deployment information “unfit for service deployment” is not set with respect to the partition to which the post-transition node belongs. If the condition is fulfilled, the process proceeds to Step S36; if not, the process proceeds to Step S42.

STEP S36: With respect to the service flow definition, the flow definition generator 143 performs a process relating to the transition of starting point. In the case of BPEL, for example, a “receive” node is generated. The process then proceeds to Step S42.

STEP S37: The target part extractor 142 determines whether or not the condition is fulfilled that the post-transition node succeeding the currently focused node is a <<SYSTEM>> action and at the same time the deployment information “unfit for service deployment” is not affixed. If the condition is fulfilled, the process proceeds to Step S39; if not, the process proceeds to Step S38.

STEP S38: With respect to the service flow definition, the flow definition generator 143 performs a process relating to the transition of terminating point. For example, in the case of BPEL, a “source” node, a “target” node and a “reply” node are generated. The process then proceeds to Step S42.

STEP S39: The target part extractor 142 determines whether or not the currently focused node and the node indicating the action after the transition belong to the same partition. If the two nodes belong to the same partition, the process proceeds to Step S40; if the two belong to different partitions, the process proceeds to Step S41.

STEP S40: The flow definition generator 143 adds, to the service flow definition, a process for <<SYSTEM>>-<<SYSTEM>> transition within an identical partition. In the case of BPEL, for example, a “source” node and a “target” node are generated. The process then proceeds to Step S42.

STEP S41: The flow definition generator 143 adds, to the service flow definition, a process for <<SYSTEM>>-<<SYSTEM>> transition between two partitions. In BPEL, for example, a “source” node, a “target” node and an “invoke” node are added as actions with respect to the currently focused node, and a “receive” node is added as an action with respect to the post-transition node. The process then proceeds to Step S42.

STEP S42: The target part extractor 142 changes the target of focus to the pos-transition node, and the process then proceeds to Step S22 in FIG. 12.

In this manner, a service flow definition is created based on the nodes 231 to 238 of which the subject of execution is <<SYSTEM>> as shown in the business process flow 200 of FIG. 8 (the partition 220 associated with the shipment management system is affixed with the deployment information “unfit for service deployment”, and accordingly, no service flow definition is created for this partition).

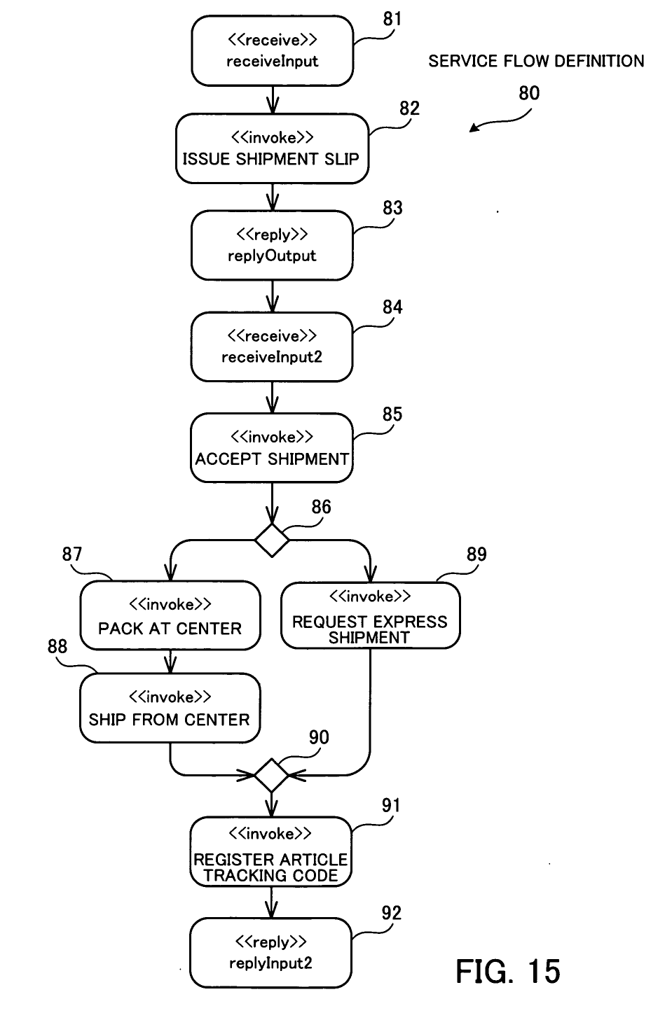

FIG. 15 shows an exemplary service flow definition. As shown in FIG. 15, the service flow definition 80 is made up of multiple nodes 81 to 92. The service flow definition 80 defines information necessary for causing the server to perform the inventory management service.

For example, the process corresponding to the shipment slip issuing node (see FIG. 8) is defined by the “receive” node 81, the “invoke” node 82, and the “reply” node 83. The “receive” node 81 indicates starting the shipment slip issue process in response to data input. The “invoke” node 82 indicates performing the shipment slip issue process based on the input data, and the “reply” node 83 indicates terminating the shipment slip issue process by outputting the processing result.

The nodes 84 through 92 of the service flow definition 80 indicate a sequence of processes from the shipment acceptance node 232 to the article tracking code registration node 238, shown in FIG. 8. The node 86 indicates a branching process, and the node 90 indicates a confluence process.

The following explains how the service flow definition 80 is described in BPEL.

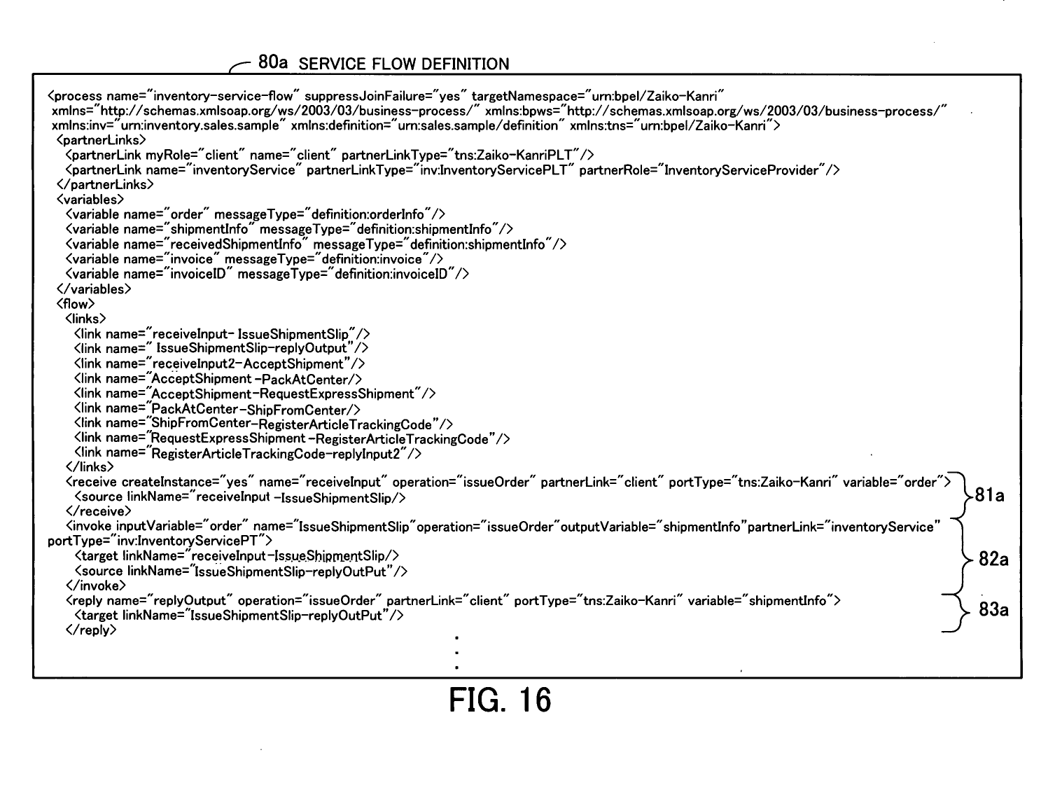

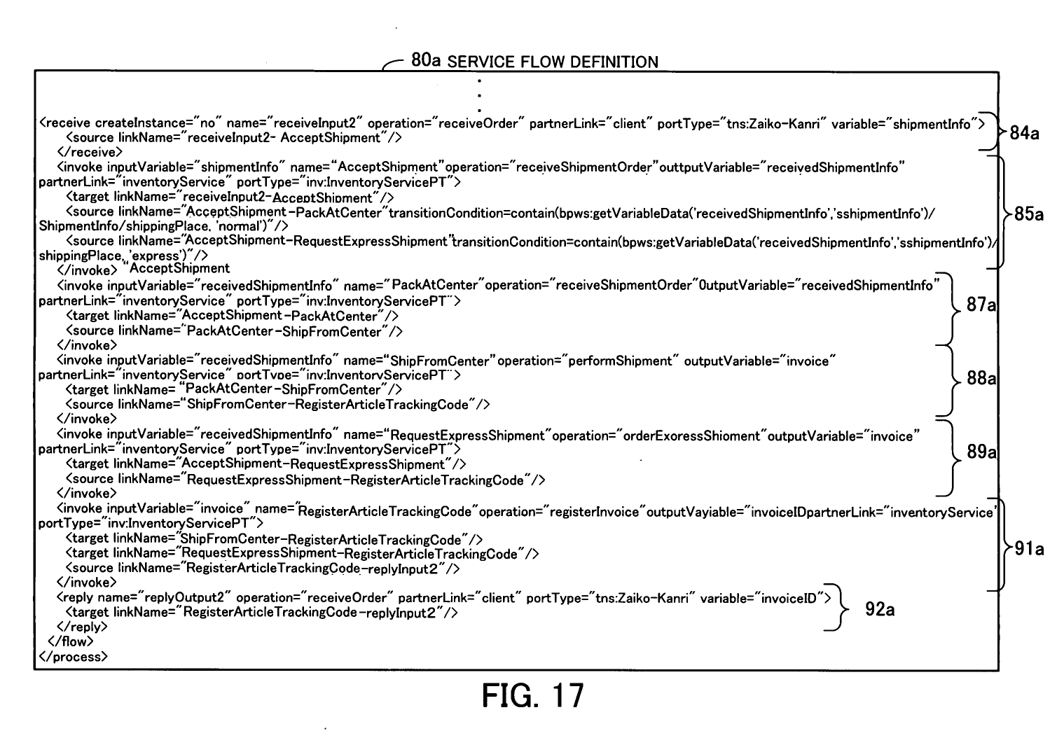

FIG. 16 is a first diagram illustrating the first half of an exemplary service flow definition 80a created by BPEL, and FIG. 17 is a second diagram illustrating the latter half of the service flow definition 80a created by BPEL.

The following relationships hold between the nodes 81 to 92 shown in FIG. 15 and the description of BPEL shown in FIGS. 16 and 17.

Referring first to FIG. 16, the node 81 corresponds to a description 81a enclosed by “receive” tags. The node 82 corresponds to a description 82a enclosed by “invoke” tags, and the node 83 corresponds to a description 83a enclosed by “reply” tags.

Referring now to FIG. 17, the node 84 corresponds to a description 84a enclosed by “receive” tags, and the node 85 corresponds to a description 85a enclosed by “invoke” tags. The node 87 corresponds to a description 87a enclosed by “invoke” tags, the node 88 corresponds to a description 88a enclosed by “invoke” tags, and the node 89 corresponds to a description 89a enclosed by “invoke” tags. The node 91 corresponds to a description 91a enclosed by “invoke” tags, and the node 92 corresponds to a description 92a enclosed by “reply” tags.

Transitional relationships among the nodes 81 to 92 shown in FIG. 15 are defined by pairs of “source” and “target” tags in the service flow definition 80a shown in FIGS. 16 and 17. A “source”-“target” tag pair with an identical “linkName” constitutes one unit of transition information, and transition is effected from the node including the “source” tag to the node including the “target” tag.

For the branching node 86 in FIG. 15, a plurality of transition destinations are set within one node so that the branching node may be defined in the BPEL-based service flow definition 80a shown in FIGS. 16 and 17. For example, the description 85a enclosed by “invoke” tags contains two “source” tags (linkName=“AcceptShipment-PackAtCenter” and linkName=“AcceptShipment-RequestExpressShipment”), whereby two transition destinations as branches are defined. In the case of conditional branching, “transitioncondition” defining a branching condition is set in a corresponding “source” tag.

Also, with respect to the confluence process 90 in FIG. 15, the confluent node is defined in the service flow definition 80a of FIGS. 16 and 17 as a destination of transitions from a plurality of source nodes. For example, the description 88a enclosed by “invoke” tags has linkName=“ShipFromCenter-RegisterArticleTrackingCode” set in its “source” tag, and the description 89a enclosed by “invoke” tags has linkName=“RequestExpressShipment-RegisterArticleTrackingCode” set in its “source” tag. The description 91a enclosed by “invoke” tags has “target” tags in which are described the link names (“linkName”) included in the “source” tags of the respective descriptions 88a and 89a. This defines the transitions from the nodes 88 and 89 corresponding to the descriptions 88a and 89a to the node 91 corresponding to the description 91a via the confluent node 90.

The following describes in detail the work flow definition generation process performed by the work flow extractor 150.

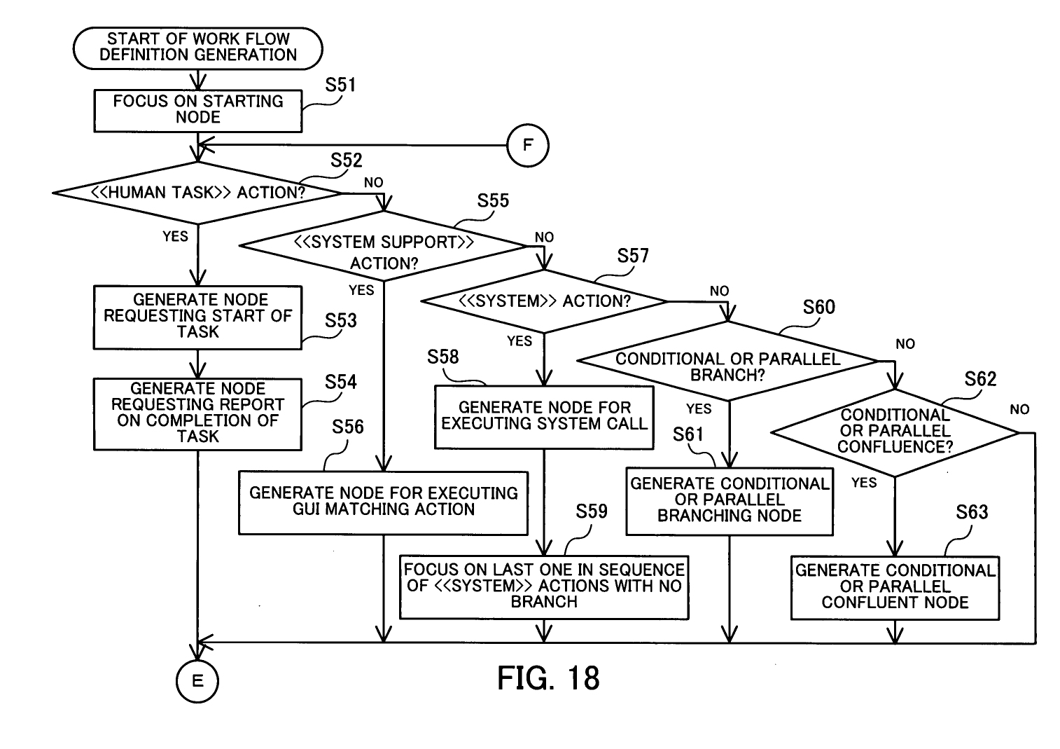

FIG. 18 is a flowchart illustrating the first half of the work flow definition generation process. In the following, the individual steps will be explained in order of step number.

STEP S51: The target part extractor 152 of the work flow extractor 150 focuses on the starting node of the business process flow.

STEP S52: The target part extractor 152 determines whether or not the currently focused node is a <<HUMAN TASK>> action. If the node is a <<HUMAN TASK>> action, the process proceeds to Step S53; if the node is an action other than the <<HUMAN TASK>> action, the process proceeds to Step S55.

STEP S53: With respect to the work flow definition, the flow definition generator 153 generates a processing node for requesting an operator to start the action.

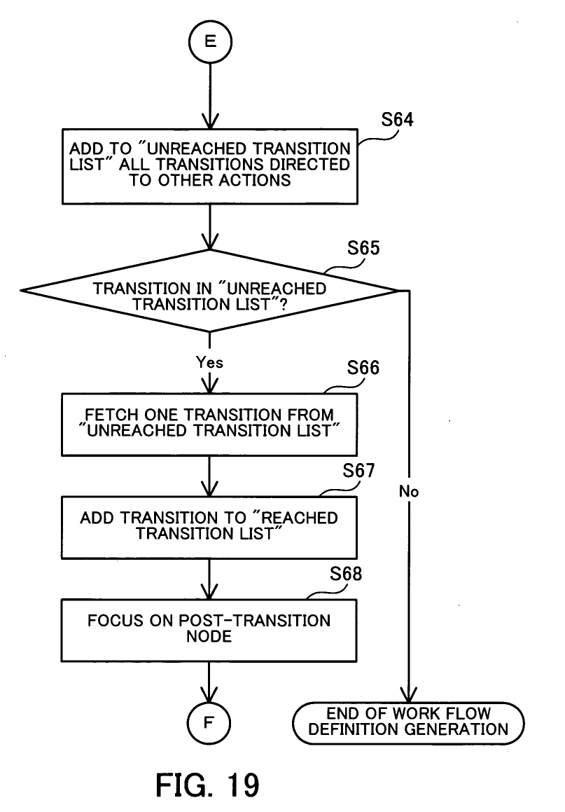

STEP S54: With respect to the work flow definition, the flow definition generator 153 generates a processing node for requesting the operator to report completion of the action, whereupon the process proceeds to Step S64 in FIG. 19.

STEP S55: The target part extractor 152 determines whether or not the currently focused node is a <<SYSTEM SUPPORT>> action. If the node is a <<SYSTEM SUPPORT>> action, the process proceeds to Step S56; if the node is an action other than the <<SYSTEM SUPPORT>> action, the process proceeds to Step S57.

STEP S56: The flow definition generator 153 generates a processing node for executing GUI whereby the action is performed. The process then proceeds to Step S64 in FIG. 19.

STEP S57: The target part extractor 152 determines whether or not the currently focused node is a <<SYSTEM>> action. If the node is a <<SYSTEM>> action, the process proceeds to Step S58; if the node is an action other than the <<SYSTEM>> action, the process proceeds to Step S60.

STEP S58: With respect to the work flow definition, the flow definition generator 153 generates a processing node for executing a system call.

STEP S59: If there is a sequence of <<SYSTEM>> actions without a branch, the target part extractor 152 focuses on the node which is the last <<SYSTEM>> action in the sequence. The process then proceeds to Step S64 in FIG. 19.

STEP S60: The target part extractor 152 determines whether or not the currently focused node is one of a conditional branching node and a parallel branching node. If the node is a conditional or parallel branching node, the process proceeds to Step S61; if the node is neither a conditional branching node nor a parallel branching node, the process proceeds to Step S62.

STEP S61: With respect to the work flow definition, the flow definition generator 153 generates a conditional or parallel branching node matching the currently focused node. The process then proceeds to Step S64 in FIG. 19.

STEP S62: The target part extractor 152 determines whether or not the currently focused node is one of a conditional confluent node and a parallel confluent node. If the node is a conditional or parallel confluent node, the process proceeds to Step S63; if the node is neither a conditional confluent node nor a parallel confluent node, the process proceeds to Step S64 in FIG. 19.

STEP S63: With respect to the work flow definition, the flow definition generator 153 generates a conditional or parallel confluent node, whereupon the process proceeds to Step S64 in FIG. 19.

FIG. 19 is a flowchart illustrating the latter half of the work flow definition generation process. The individual steps will be explained in order of step number.

STEP S64: The target part extractor 152 adds, to an “unreached transition list”, transition information on all transitions directed to other actions. In this case, however, the transition information included in a “reached transition list” is excluded.

STEP S65: The target part extractor 152 determines whether or not there is transition information in the “unreached transition list”. If transition information exists, the process proceeds to Step S66; if not, the process ends.

STEP S66: The target part extractor 152 fetches transition information from the “unreached transition list”. The transition information thus fetched is deleted from the “unreached transition list”.

STEP S67: The target part extractor 152 adds the fetched transition information to the “reached transition list”.

STEP S68: The target part extractor 152 focuses on the post-transition node identified by the fetched transition information, and the process then proceeds to Step S52 in FIG. 18.

In this manner, a work flow definition is generated. In the case of the business process flow 200 shown in FIG. 8, for example, the work flow definition is generated based on the nodes 212 to 216 whose subject of execution is <<SYSTEM SUPPORT>> or <<HUMAN TASK>>.

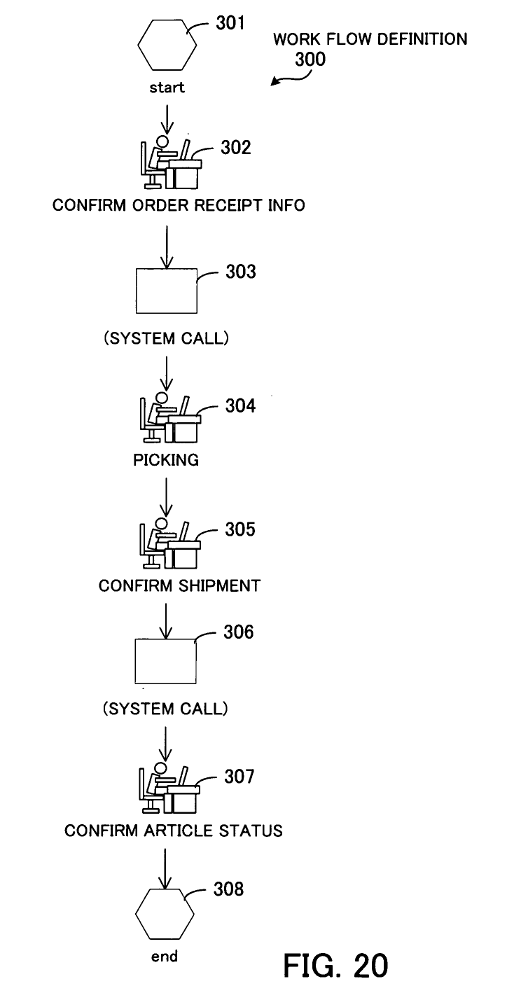

FIG. 20 illustrates an exemplary work flow definition. As shown in FIG. 20, the work flow definition 300 is constituted by a plurality of nodes 301 to 308. In the figure, the starting and terminating nodes 301 and 308 are each indicated by a hexagon. The nodes 303 and 306, which indicate processes automatically executed by the system, are each indicated by a rectangle. Also, the nodes 302, 304, 305 and 307, which indicate processes (system call processes) using GUI involving a human task and a user's input operation, are each indicated by a pictograph showing a person at desk.

The node 302 is the order receipt information confirmation process corresponding to the node 212 shown in FIG. 8. The node 303 corresponds to a process of calling the shipment slip issue process of the inventory management service, receiving a response to the call, and presenting items for picking. The node 304 is the picking process corresponding to the node 214 shown in FIG. 8, and the node 305 is the shipment confirmation process corresponding to the node 215 in FIG. 8. The node 306 is a process of sending an input and confirmed shipment slip to the inventory management service and receiving an article tracking code as a response thereto. The node 307 is the article status confirmation process corresponding to the node 216 in FIG. 8.

Nodes to be extracted for creating a service or work flow definition can be changed by optionally setting a specific condition for specifying a part flow which can be automatically executed without the need for a human task. Also, the description format according to which service and work flow definitions are generated can be modified as needed.

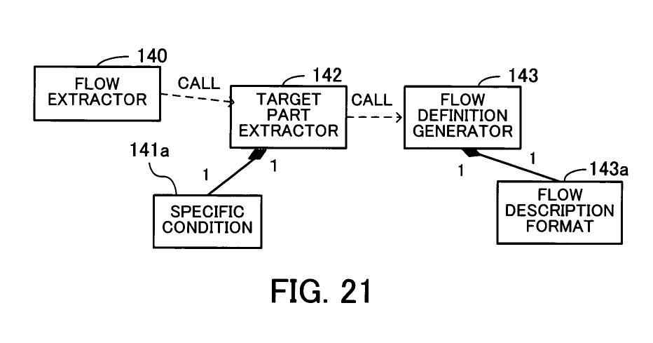

FIG. 21 illustrates the manner of how the specific condition and the flow description format are looked up. As shown in FIG. 21, the control function of the service flow extractor 140 calls the target part extractor 142, which then looks up a specific condition 141a to identify elements to be extracted. Also, the target part extractor 142 calls the flow definition generator 143, which then looks up a flow description format 143a to generate a service flow definition in the description format specified by the flow description format 143a.

In this relationship, elements to be extracted from the business process flow can be changed by changing the contents of the specific condition 141a. Also, by changing the flow description format 143a, it is possible to change the description format of a service flow definition to be generated.

Meanwhile, if the target part extractor 142 is adapted to perform the function of processing all conditions that can be set as the specific condition 141a, the resulting program etc. may possibly become enormous in scale. Accordingly, the target part extractor may be configured such that the target part specification function can be switched in accordance with change of the specific condition. Similarly, the flow definition generator may be configured such that the service flow generation function can be switched in accordance with change of the flow description format.

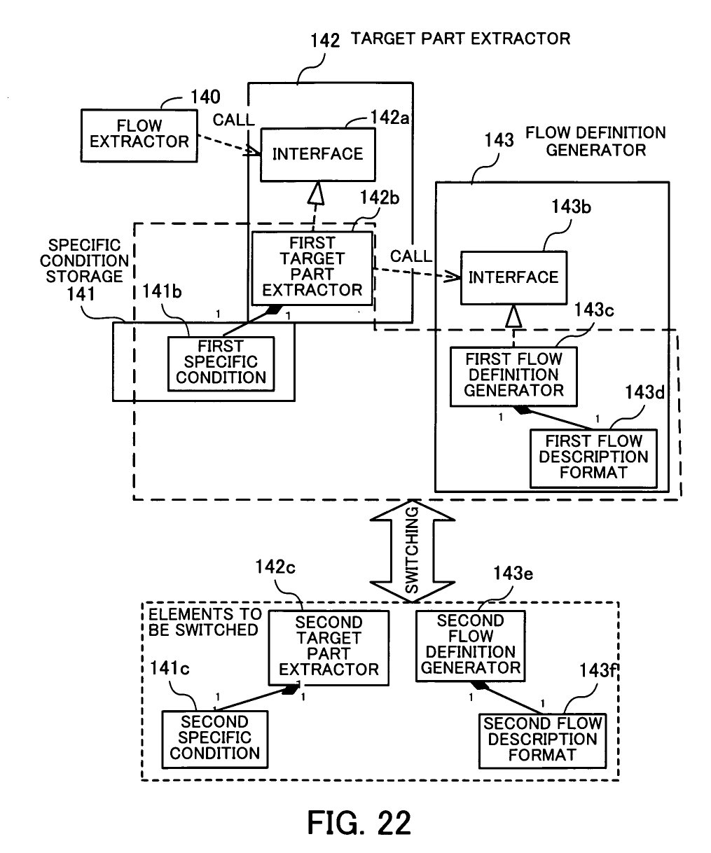

FIG. 22 illustrates a configuration whereby the target part specification function and the flow definition generation function can be switched. In the illustrated example, the function of the target part extractor 142 is divided into an interface 142a and a first target part extractor 142b. When called by the service flow extractor 140, the interface 142a causes the currently set first target part extractor 142b to perform the necessary process. Specifically, the first target part extractor 142b extracts, from the business process flow, elements satisfying a first specific condition 141b stored in the specific condition storage 141.

Similarly, the function of the flow definition generator 143 is divided into an interface 143b and a first flow definition generator 143c. When called by the first target part extractor 142b, the interface 143b causes the currently set first flow definition generator 143c to perform the necessary process. Specifically, the first flow definition generator 143c generates a service flow definition in the description format specified by a first flow description format 143d.

As elements to be switched, a second target part extractor 142c, a second specific condition 141c, a second flow definition generator 143e and a second flow description format 143f are prepared beforehand. To switch the specific condition and the flow description format, the first target part extractor 142b, the first specific condition 141b, the first flow definition generator 143c and the first flow description format 143d are replaced with the respective elements.

Thus, the specific condition and the flow description format can be changed with ease.

As described above, service and work flow definitions can be separately and automatically generated on the basis of the business process flow. Accordingly, even if need for design change of the business process flow arises afterwards, the vendor side has only to modify the business process flow in accordance with the items agreed upon with the operator side and it is unnecessary to perform a redundant process of manually creating service and work flow definitions. It is therefore possible to save the labor and time required to generate service and work flow definitions and also to prevent the system construction from being delayed due to the re-creation of service and work flow definitions.

The processing function described above can be performed by a computer. In this case, a program is prepared in which is described the process for performing the function of the system management server 100. The program is executed by a computer, whereupon the aforementioned processing function is accomplished by the computer. The program describing the process may be recorded on computer-readable recording media. As such computer-readable recording media, magnetic recording devices, optical discs, magneto-optical recording media, semiconductor memories, etc. may be used. Magnetic recording devices include a hard disk drive (HDD), a flexible disk (FD), a magnetic tape, etc. Optical discs include a DVD (Digital Versatile Disc), a DVD-RAM (Random Access Memory), a CD-ROM (Compact Disc Read Only Memory), a CD-R (Recordable)/RW (ReWritable), etc. Magneto-optical recording media include an MO (Magneto-Optical disk) etc.

To market the program, portable recording media, such as DVDs and CD-ROMs, on which the program is recorded may be put on sale. Alternatively, the program may be stored in the storage device of a server computer and may be transferred from the server computer to other computers via a network.

A computer which is to execute the program stores in its storage device the program recorded on a portable recording medium or transferred from the server computer, for example. Then, the computer loads the program from its storage device and performs the process in accordance with the program. The computer may load the program directly from the portable recording medium to perform the process in accordance with the program. Also, as the program is transferred from the server computer, the computer may sequentially execute the process in accordance with the received program.

According to the present invention, part flows are generated on the basis of the subject of execution-related information set in a business process flow, and therefore, part flow definitions, such as a service flow definition defining automatically executable processes and a work flow definition defining processes involving input operations by humans, can be automatically created. Accordingly, even if the business process flow is changed in content, the changes can be instantly reflected in the part flow definitions, thus preventing delay in the system deployment based on the part flow definitions.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium recording a part flow definition generation program for causing a computer to generate, based on a business process flow describing a procedure of business processes by means of multiple nodes, a part flow definition defining a procedure for performing part of the business processes,
wherein the part flow definition generation program causes the computer to function as:
business process flow storage means for storing a business process flow in which a subject of execution is set with respect to each of the nodes associated with respective processes;
specific condition storage means for storing a specific condition including a subject of execution-based criterion as a criterion for identifying nodes that are to constitute a part flow definition, from among those in the business process flow;
target part extractor means for extracting, from the business process flow, the nodes satisfying the specific condition stored in the specific condition storage means; and
part flow definition generator means for generating the part flow definition by defining, in accordance with the procedure defined in the business process flow, transition information indicative of process transition relationship between the nodes extracted by the target part extractor means.

2. The computer-readable recording medium according to claim 1, wherein the business process flow storage means stores a business process flow specifying that predetermined ones of the nodes are to be executed by a computer system as the subject of execution, and
wherein the specific condition storage means stores a specific condition for extracting the predetermined nodes to be executed by the computer system.

3. The computer-readable recording medium according to claim 1, wherein the business process flow storage means stores a business process flow specifying that predetermined ones of the nodes are to be executed by a human task as the subject of execution, and
wherein the specific condition storage means stores a specific condition for extracting the predetermined nodes to be executed by the human task.

4. The computer-readable recording medium according to claim 1, wherein the business process flow storage means stores a business process flow specifying that predetermined ones of the nodes are to be executed by a human task or by an input operation by a human with aid of a computer system, as the subject of execution, and
wherein the specific condition storage means stores a specific condition for extracting the predetermined nodes involving humans.

5. The computer-readable recording medium according to claim 1, wherein the specific condition storage means stores a plurality of specific conditions, and
wherein the target part extractor means extracts, from the business process flow, nodes satisfying a specific condition optionally selected from among the specific conditions stored in the specific condition storage means.

6. The computer-readable recording medium according to claim 1, wherein the part flow definition generation program causes the computer to function further as deployment information affixer means for affixing information necessary for deployment to the business process flow, and
wherein the part flow definition generator means generates a part flow definition deployable to a computer system, based on the deployment information affixed to the business process flow.

7. The computer-readable recording medium according to claim 1, wherein the part flow definition generator means generates the part flow definition with a description format of the business process flow converted into a predetermined description format.

8. A part flow definition generation method for causing a computer to generate, based on a business process flow describing a procedure of business processes by means of multiple nodes, a part flow definition defining a procedure for performing part of the business processes, comprising the steps of:
preparing in advance business process flow storage means storing a business process flow in which a subject of execution is set with respect to each of the nodes associated with respective processes;
storing, in specific condition storage means, a specific condition including a subject of execution-based criterion as a criterion for identifying nodes that are to constitute a part flow definition, from among those in the business process flow;
causing target part extractor means to extract, from the business process flow, the nodes satisfying the specific condition stored in the specific condition storage means; and
causing part flow definition generator means to generate the part flow definition by defining, in accordance with the procedure defined in the business process flow, transition information indicative of process transition relationship between the nodes extracted by the target part extractor means.

9. A part flow definition generation device for generating, based on a business process flow describing a procedure of business processes by means of multiple nodes, a part flow definition defining a procedure for performing part of the business processes, comprising:
business process flow storage means for storing a business process flow in which a subject of execution is set with respect to each of the nodes associated with respective processes;
specific condition storage means for storing a specific condition including a subject of execution-based criterion as a criterion for identifying nodes that are to constitute a part flow definition, from among those in the business process flow;
target part extractor means for extracting, from the business process flow, the nodes satisfying the specific condition stored in the specific condition storage means; and
part flow definition generator means for generating the part flow definition by defining, in accordance with the procedure defined in the business process flow, transition information indicative of process transition relationship between the nodes extracted by the target part extractor means.
